(19) United States
(12) Patent Application Publication
(10) Pub. No.: US 2014/0349044 A1
(43) Pub. Date: Nov. 27, 2014

(54) SCENTED PREPARATION COMPRISING SCENTED COMPOUND

(71) Applicants: Janne Jarvenpaa, Veikkola (FI); Juha Pippuri, Vantaa (FI)

(72) Inventors: Janne Jarvenpaa, Veikkola (FI); Juha Pippuri, Vantaa (FI)

(73) Assignee: KA AROMA MARKETING OY, Helsinki (FI)

(21) Appl. No.: 14/371,552

(22) PCT Filed: Jan. 11, 2013
(86) PCT No.: PCT/FI2013/050023

§ 371 Date: Jul. 10, 2014

(30) Foreign Application Priority Data
Jan. 11, 2012 (FI) 20125029

(51) Int. Cl. B41M 3/00; C09D 11/02; B41F 15/00; C11B 9/00

(52) U.S. Cl. CPC B41M 3/006; C11B 9/00; C09D 11/02; B41F 15/00
USPC 428/35.2; 512/4; 106/31.02; 101/129; 428/195.1; 428/196; 428/34.1

(57) ABSTRACT

The invention relates to a scented preparation that comprises a scented compound, as well as to a method for its manufacture. The invention relates also to a method for manufacturing a product comprising scented-compound, as well as to the use of such a product. The scented preparation according to the invention comprises at least one scented compound and a carrier, as well as a binder for blending and bonding the scented compound and the carrier with and to each other.

### TECHNICAL BACKGROUND

The invention relates to a scented preparation comprising a scented compound, as well as to a method for its manufacture. The invention relates also to a method for manufacturing a product comprising scented-compound-, as well as to the use of such a product.

Products have been traditionally supplemented with scented compounds by dosing those directly to a base material either by immersion or by spraying scented compounds e.g. onto a printed product. A problem with prior known technologies is that the either the dosage of a scented compound is laborious and expensive or the methods do not enable the dosage of a scented compound in sufficiently large quantities onto a printed product. The scent can also be provided by encapsulating an aromatic substance and breaking this apart subsequently by abrading and scraping. This method is also laborious and technically complicated. There is also a prior known method, in which a scented compound is added to a product in the form of a supplement in printing ink, varnish and/or adhesive.

### GENERAL DESCRIPTION OF THE INVENTION

What has been invented now is a scented preparation comprising scented-compound, which is technically in a highly beneficial form in view of supplementing a product therewith. Another object of the invention is a method for manufacturing a product comprising scented-compound, as well as the use of such a product.

In order to attain this objective, the invention is characterized by what has been presented in the independent claims. Other claims disclose a few preferred embodiments of the invention.

The scented preparation according to the invention comprises at least one scented compound and a carrier, as well as a binder for blending and bonding the scented compound and the carrier with and to each other.

There are a variety of ways of manufacturing a scented preparation that comprises a scented compound, and the printing area may be located in various parts of the product. The carrier may vary as required by a scented compound and according to intended use of the product. The carrier can be for example an adhesive or some other formulation of that type. The carrier can be water-based or it can be solvent-based.

According to one object of the invention, the binder consists of a surfactant for blending and bonding a carrier. The surfactant consists preferably of an anionic surface-active agent. Preferably, the surfactant consists of SDS (sodium lauryl sulfate). The concentration of SDS can be e.g. 0.5-2% (w/v), such as preferably more than 0.8% (w/v) or more than 1% (w/v), thus providing a technically highly beneficial scented formulation for supplementing a product. The scented formulation can thereby be provided in a form to enable its convenient addition to the actual product by means of screen printing technique.

According to one object of the invention, the scented formulation further comprises at least one silicate compound for enhancing the bonding of a scented compound. The silicate compound alters the product's viscosity and may further bond a scented compound more effectively to the solution. The silicate compound may vary as required by the intended use.

The use of a separate binder improves substantially the method in terms of its effectiveness with respect to prior known solutions. The addition of a scented compound can now be optimized very effectively without accompanying changes in other screen printing conditions. The dosage of a scented compound becomes particularly precise, and operation of the process, both in terms of the scented compound itself and the rest of it, can be adjusted as required at any given time. Printing a binder and a scented formulation onto a product is an easy and technically simple solution. The printing does not require a separate apparatus while generally achieving in printing the highly significant benefits provided by screen printing technique. Thus, the addition of a scented compound is technically a highly effective operation. At the same time, it also makes very good economic sense.

The product according to the invention may comprise just a scented formulation and a binder, or it may comprise also other compounds printed with screen printing technique and by other means. The method can be used for manufacturing e.g. shirts, on which is subsequently printed e.g. a desired pattern or color. Hence, this novel method provides even in that sense a substantial advantage over prior known techniques.

According to one object of the invention, the method further comprises printing one or more printing inks, varnishes and/or adhesives on a printing area by using screen printing technique. According to one object of the invention, at least one scented formulation is printed on a printing area prior to the printing of a printing ink, varnish and/or adhesive. According to one object of the invention, at least one scented formulation is printed on a printing area during the printing of a printing ink, varnish and/or adhesive. According to one object of the invention, at least one scented formulation is printed on a printing area after the printing of a printing ink, varnish and/or adhesive. The usability of the method in various applications is diversified by this/these and its usefulness is expanded to a wide range of printing solutions.

According to one object of the invention, the scented formulation and/or the binder is supplemented with accelerants for enhancing the bonding of a scented compound. This is used for ensuring and adjusting and enhancing the method to make it optimal.

According to one object of the invention, the product is oven-treated after screen printing. This expedites drying and manufacture in general. In addition, it improves handling of the product.

The product's base material can be selected e.g. from a group, comprising paper, paperboard, cardboard, a wood product, plastic, rubber, metal, glass, a ceramic product, textile. According to one object of the invention, the product is a fibrous product, such as for example textile. The advantages of using a separate binder become evident especially in the printing of fibrous products. The method lends itself particularly well e.g. to the printing of textiles. According to one object of the invention, the product has also printed on its base material, with some other printing technique, such as offset technique, at least one printing ink, adhesive and/or varnish. Hence, the method can be utilized for highly diverse applications. It can be in use as early as in the initial product processing or even in the after-processing of the product, or it can be in use in hybrid printing technique.

The product comprising scented-compound manufactured according to the invention can be used e.g. as a product included in a group, wherein: the product is a fibrous product, such as textile, fabric, felt, cotton, textile, accessory, sweatband, wristband, garment, trousers, shirt, flat cap, knit cap, headgear, bag, pouch, beer coaster, cardboard cutout, sales stand, storage case, display case, brochure and illustrated catalogue, binder, folder, mobile, table rack, floor rack, shelf wobbler, product package, packaging material, case, box, brochure, calendar, ruler, display, container, dispenser, glass coaster, business card, illustrated catalogue, form, envelope, holdall, bag, pad, writing pad, plastic sleeve, briefcase, pocket, background advertisement, product information card, tablecloth, table talker, box or some other article or product designed for sales promotion, marketing, direct mailing. The product can be a semi-finished or finished product, and it can be targeted e.g. for sales and marketing and also for the consumer.

Regarding ink, varnish and adhesive, the transfer capacity of screen printing technique is multiple, as high as 10-fold, with respect to e.g. offset printing technique. Consequently, the scented compound to be transferred has also a proportionally multiple transfer capacity. Hence, the use of screen printing technique provides an essential advantage over other printing techniques in the transfer of a scented compound. The use of a separate binder provides a further significant improvement therein, because even the printing itself can now be optimized.

Screen printing technique refers in this application to a printing technique, wherein inks are rationed through a screen onto a product to be printed. Screen printing is also generally referred to as silk screen printing as it was originally carried out with silk screens. In principle, the invention is applicable to all sorts of screen printing technique, including the use of manual and semi-automatic techniques, as well as also automated lines with screens or a printable product traveling thereon. The screen properties may vary as desired. In fact, the screen density can be used for making a difference regarding e.g. the amount of ink and scented compound to be printed on a product. When using a dense screen, the amount of ink is less than with a coarse sieve and, respectively, the amount of a scented compound also varies according to the screen density.

The manufacture of such a product is especially beneficial in technical sense, because the dosage of the product is precise, easy, and simple. It is e.g. easy to ration a sufficient amount of scented compound. The method lends itself well to a wide variety of base materials, and the scented compound need not be absorbed or bound by the base material itself.

A particular benefit provided by a product manufactured with the method with respect to the prior art is that the amount of a scented compound in the product can be readily and accurately regulated thereby. The mode of printing also provides a benefit of enabling the regulation of its release. It is e.g. possible to manufacture a product, wherein a scented compound is printed with screen printing technique into inks, and that is then partly coated with a breathable varnish. In this case, the scented compound releases from the product over a long time. Respectively, a scented compound can be printed on the product in combination with a surface varnish, whereby it releases relatively more quickly and in higher concentrations.

The scented compound can be any substance, compound or mixture emitting at least some type of olfactory or measurable fragrance. It may comprise just one such substance, compound or mixture, or it may comprise two or more substances, compounds and/or mixtures in various proportions. The scented compound may also be a plant or a part thereof, which comprises one or more scent-producing substances, compounds or mixtures. The scented compound can also be e.g. a plant extract. The particular scented compound refers in this application to such a compound which is mainly or at least partially responsible for producing a particular discussed scent. However, the scent of such a particular scented compound may fluctuate, e.g. the scent of an apple can be that of a sour apple or a sweet apple, and e.g. the scent of bread can have a wide range of variations.

According to one object of the invention, the product, which has been printed with screen printing technique, is further printed with embossed symbols, depressions and holes, such as embossed symbols by Braille technique or some other similar technique. Provided thereby are preferably combinations for use e.g. by the blind or visually impaired. It can also be found preferably useful whenever the product is handled e.g. in semidarkness.

According to one object of the invention, the scented compound is allergy tested and/or of the type that does not cause allergy, hypersensitivity, light sensitivity or general irritation for those exposed to its influence. The use of such products is particularly safe in a variety of applications. The scented compound can also preferably be applied as a food grade product.

According to one object of the invention, the scented compound comprises one or more organic scented compounds. These make applications of the invention even more versatile. These achieve e.g. scent combinations, which would otherwise have to be worked out with scented raw materials. Combining for example the scent of raw tobacco with that of vanilla results in a combination resembling vanilla flavored cigar. According to one object of the invention, the scented compound comprises one or more inorganic scented compounds. These diversify applications of the invention even further.

According to one object of the invention, at one scented compound is selected from a group, including paper inks, plastic inks, textile inks, UV inks The paper inks can be solvent- or water-based. Further applicable are various degrees of gloss, i.e. inks with a matt or glossy finish. In addition to this, it is possible to use a scratch-off ink used e.g. in lottery tickets, or a fluorescent ink, which thus absorbs light and glows in the dark, or light-reflecting inks. Such an application can be utilized whenever it is desirable to achieve at the same time both a color attraction and an odor attraction, such as e.g. in the manufacture of fishing lure coatings or e.g. in scented reflectors or scented hunting jackets with a purpose of hiding a specific human odor shunned by animals.

As a general rule, plastic inks are all solvent-based. Matt and glossy finish options are available also in plastic inks. It is also possible to employ e.g. 2-component plastic inks for metal surfaces. Plastic inks may further comprise pigment or base paste colors used in breaking the colors or as a primer.

Textile inks are generally divided into plastisol, 1- or 2-component, as well as watercolor-based inks. Also useful are various coating inks, fluorescent inks and thinners.

The invention enables making use of also ultraviolet light-curable inks. These are similar to other inks, yet require ultraviolet light for drying.

The mixing of inks can take place at a printing plant, or else the plant may order a specific tone ink directly from an ink supplier.

One object of the invention is provided with one or more scented compounds selected from a group, comprising:

a scented compound of some tar product, such as a scented compound of thin liquid pine tar or pine tar pit

a scented compound of some smoke, such as a scented compound of chimney-less sauna or tar smoke

a scented compound of some beverage, such as a scented compound of coffee, hot chocolate, tea, mead, wine, or beer

a scented compound of some plant, such as a scented compound of mint or birch

a scented compound of some space, such as a scented compound of garlic, black pepper or white pepper

a scented compound of some fruit, such as a scented compound of apple

a scented compound of some flower, such as a scented compound of rose or lily of the valley

a scented compound of some foodstuff, such as a scented compound of bread, pastry, smoke-cured meat or smoked fish

a scented compound of some animal, such as a scented compound of horse

a scented compound of some berry, such as a scented compound of raspberry.

The invention has a very extensive range of optional applications in highly diverse projects. These enable applications of the invention to be diversified even further.

1. A scented preparation, which comprises a scented compound, characterized in that the scented preparation comprises at least one scented compound and a carrier, as well as a binder for blending and bonding the scented compound and the carrier with and to each other.

2. A scented preparation as set forth in claim 1, characterized in that the binder consists of a surfactant.

3. A scented preparation as set forth in claim 2, characterized in that the surfactant consists of an anionic surface active agent, such as SDS.

4. A scented preparation as set forth in claim 1, characterized in that it further comprises at least one silicate compound for enhancing the bonding of the scented compound.

5. A scented preparation as set forth in claim 1, characterized in that it further comprises at least one accelerant for enhancing the bonding of the scented compound.

6. A scented preparation as set forth in claim 1, characterized in that it comprises a printing ink/printing inks, varnish/varnishes and/or adhesive/adhesives.

7. A scented preparation as set forth in claim 1, characterized in that the carrier is water-based.

8. A scented preparation as set forth in claim 1, characterized in that the carrier is solvent-based.

9. A method for manufacturing a scented preparation that comprises a scented compound, characterized in that the scented preparation is arranged to comprise a scented compound and also a carrier, as well as a binder for blending and bonding the scented compound and the carrier with and to each other.

10. A method for manufacturing a product that comprises a scented compound, characterized in that the method comprises at least the following step of:
printing on at least one printing area of the product with screen printing technique any scented preparation as set forth in claim 1.

11. A method as set forth in claim 10, characterized in that the method further comprises at least the following step of:
printing on the printing area with screen printing technique one or more printing inks, varnishes and/or adhesives.

12. A method as set forth in claim 11, characterized in that at least one scented preparation is printed on the printing area prior to printing the printing ink, varnish and/or adhesive.

13. A method as set forth in claim 11, characterized in that at least one scented preparation is printed on the printing area during the course of printing the printing ink, varnish and/or adhesive.

14. A method as set forth in claim 11, characterized in that at least one scented preparation is printed on the printing area after printing the printing ink, varnish and/or adhesive.

15. A method as set forth in claim 10, characterized in that the screen printing is followed by oven-treating the product.

16. A product comprising scented-compound, manufactured with any method as set forth in claim 10.

17. A product as set forth in claim 16, characterized in that the product is a fibrous product, such as textile, fabric, felt, cotton, textile, accessory, sweatband, wristband, garment, trousers, shirt, flat cap, knit cap, headgear, bag, pouch, beer coaster, cardboard cutout, sales stand, storage case, display case, brochure and illustrated catalogue, binder, folder, mobile, table rack, floor rack, shelf wobbler, product package, packaging material, case, box, brochure, calendar, ruler, display, dispenser, glass coaster, business card, illustrated catalogue, form, envelope, holdall, bag, pad, writing pad, plastic sleeve, briefcase, pocket, background advertisement, product information card, tablecloth, table talker, box or some other article or product designed for sales promotion, marketing, direct mailing.

18. The scented preparation as set forth in claim 3, further comprising at least one silicate compound for enhancing the bonding of the scented compound.
